(19) United States
(12) Patent Application Publication
(10) Pub. No.: US 2010/0092910 A1
(43) Pub. Date: Apr. 15, 2010

(54) REFERENCE SUPPORT FOR A DENTAL IMPLANT, A RADIOGRAPHIC AND/OR TOMOGRAPHIC REFERENCE SUPPORT MOUNTING FRAME AND A PROSTHETIC CROWN SOUNDING GUIDE

(76) Inventors: Asbel Rodrigues Machado, Uberlandia (BR); Eder Ferreira Rangel, Uberlandia (BR); Keuler Ferreira Rangel, Uberlandia (BR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/248,377

(22) Filed: Oct. 9, 2008

(51) Int. Cl. A61C 3/00

(52) U.S. Cl. 433/75

(57) ABSTRACT

A reference support for a dental implant, which includes a body defining a first main portion having two free ends, a respective prolonged orthogonal portion projecting from each end, the first main portion and the two prolonged orthogonal portions defining a space, the support further including members for association of another device such as a guide tube positioning apparatus or a prosthetic crown sounding guide or the like.

### CROSS-REFERENCE TO RELATED APPLICATION

The present application is related to U.S. patent application Ser. No. 11/______ (“the '______ application”), entitled “Guide Tube and Guide Tube Positioning Device”, filed on the same day as the present application, the entire disclosure of which is incorporated herein by reference.

### BACKGROUND OF THE INVENTION

The present invention relates to a reference support for a dental implant, for tomographic or radiographic use, which is reliable as a fixing base and also capable of enabling the obtainment of the data necessary to carry out the correct planning of the alveolar bone boring in a patient's mouth, for positioning a dental implant.

The present invention also relates to a radiographic and/or tomographic reference support mounting frame, which makes it possible to mount the support in a given specified position, facilitating and rendering more precise the surgical planning and the execution of the dental implantation.

Further, the present invention relates to a prosthetic crown sounding guide for carrying out prosthetic crown sounding operations, previously installed on the reference support for the above-mentioned dental implantation.

The technique of carrying out a dental implantation requires a umber of process steps, until the implant is correctly and firmly positioned in place.

A dental implant is an element fixed to the bone portion of the patient's jaw, which enables one to fix a prosthetic crown (a synthetic tooth) at the location where a natural tooth was originally positioned.

In order to fix an implant correctly, it is necessary to drill the bone portion at the most appropriate location for this. In this hole one positions the implant, which rapidly interacts with the bone tissue and becomes correctly fixed.

The procedure of boring the bone portion of the patient should be carefully studied, since making the hole at an inadequate location may impair the result of the implant, both aesthetically and sometimes functionally, if the fixation is rendered difficult because of the incorrect position of the hole.

In studying the correct location for making the hole, one should consider many variables, such as the bone constitution of the patient, the shape and positioning of the implant, a possible loss of bone as a result of the inadequate mouth cleaning, among others.

For making this study, the professional resorts to clinical and image examinations such as tomography and radiography, which enable an effective view of the bone constitution of the patient's face. However, especially when radiographic equipment is used, the images that can be obtained present distortions that prevent the unrestricted use thereof, for which reason the professional has to compensate for this distortions in order to achieve an efficient result.

In possession of the results of these examinations, the professional makes a mold (generally from gypsum) of the dental arcade of the patient and then makes a plate that fits tightly and precisely with the model. This plate may be made in various ways known to a person skilled in the art and ends up having the function of a template for making the hole.

After making the plate, a number of studies are made for, in the last analysis, positioning the drill, in order to make the hole correctly. However, in this step, without the use of a system that provides the data necessary to the planning, often the only variable to determine the positioning of the drill is the experience of the dental professional.

With a view to carry out the implantation, notably as far as precision in making the hole is concerned, a number of solutions have come up, some of which are mentioned hereinafter.

U.S. Pat. No. 7,097,451 relates to a thermoplastic template for making dental implants and a method for carrying out this procedure. The template comprises a malleable thermoplastic base and a rigid drill guide tube positioning in the mouth. The guide tube is attached to the plate by means of a locking element.

The base material is preferably any material having a softening and melting point at relatively low temperature, concomitant with high rigidity at room temperature, besides enabling malleability while cools down to room temperature, the moment when the guide tube should be positioned in an accurate manner.

It should be noted that the main focus of that document is the constitution of the template. It does not disclose how to determine the correct positioning of the drill guide.

U.S. Pat. No. 5,556,278 discloses a method for correctly positioning the hole of an implant by using a template and a positioning arm. However, due to the dimensions and weight of the arm, it is difficult to insert the drill and handle it to make the hole in the patient's mouth, even when it is anesthetized. This is a relatively rudimentary technique.

Document WO 2006/130068 relates to an instrument for enabling the correct orientation of a drill or guide to make holes that enable the installation of a dental implant. Such an instrument comprises two retaining arms, which are attached to the template, as well as guide arms, the function of which is to determine the holes for applying the template.

After this, by applying the instrument in the anesthetized patient's mouth, the correct orientation is achieved by placing the template where it is oriented with the respective mark. In this way, the system enables one to drill the hole at the exact location where it should be, thus guaranteeing the success of the operation.

As a great drawback in this invention, there is the need to install the equipment in the user's mouth to check the marking. And due to large dimensions, the discomfort of the patient is certain, even if he is anesthetized.

U.S. Pat. No. 7,44,735 relates to a method for installation of a dental implant that includes the steps of positioning a guide tube adjacent the patient's bone and, after obtaining tomographic images, creating a computer-aided image, so as to determine the exact location for the hole where the implant will be positioned.

Such a system requires high financial resources due to the compulsoriness of using the tomographic equipment, which is beyond the reach of the health units of the great majority of cities in economically less developed regions.

German document DE 202005008782 relates to the process of making a template, especially designed for positioning drill guides to make implants, comprising at least one, but preferably two planes or fasteners for fastening X-ray films, a source locating light or a laser beam and an arm for performing the procedures necessary for positioning the drill guides correctly.

U.S. Pat. No. 5,015,183 describes a method that uses a radiopaque material installed in the patient's mouth, after which a large number of X-ray pictures are made so that one can determine the correct positioning of the hole in the bone portion of the patient. However, the large number of X-ray pictures required exposes the patient excessively and increases the cost of the procedure.

This document discloses a quite sophisticated piece of equipment for determining the correct positioning of the guide tubes, which excessively limits the use thereof at places less developed economically.

U.S. Pat. No. 7,086,860 describes a method that uses an acrylic plate with perforations to perform the transgingival sounding technique in the region where one intends to install an implant, combined with the use of a transparent plastic sheet with imprinted details to feed the radiographic image obtained from the same region and that transfers the result of the transgingival sounding to a gypsum model of the patient's arcade by making cuts in said model in the region corresponding to the sounding. This method proves to be inefficient because it does not foresee mechanism that guarantee the performance of a standardized radiographic technique, which prevent distortions or that compensate with the degree of enlargement of the radiographic image obtained. Besides, the fact of cutting out the model on which the surgical guide will be made takes additional time and certainly introduces inaccuracy in the process because it does not preserve the integrity of said model.

In short, even though there are various technologies for making dental implants in accuracy in the hole made in the bone portion of the patient, most of them use sophisticated equipment and computer-aided measuring equipment, which are of impracticable acquisition for the health units in most of the economically less developed regions. Other resort to methods that use relatively simple equipment, but, because they require a too toilsome process and mainly because they do not provide means that guarantee the security of the data obtained, end up casting doubt on the security of the method.

Thus, until the present moment no reference equipment or systems had been developed so as to enable to carry out the installation of a dental implant on a patient with millimetric precision, which would not require heavy investments in high-technology apparatus and which would be easy to use by dental professionals.

### BRIEF SUMMARY OF THE INVENTION

The present invention has the objective of providing a reference support for a dental implant, especially for tomographic use, which enables the planning to determine the position for making the hole for installation of the implant with millimetric precision and that is inexpensive so as to render its use feasible even by health units of economically less-favored regions.

The present invention also has the objective of providing a reference support for a dental implant, especially for tomographic use, which enables the planning to determine the position for making the hole for installation of the implant with millimetric precision and that serves as fixation base for guide tube positioning equipment, such equipment being of more simple and less expensive industrial construction, even for health units of economically less-favored regions.

The present invention has the further objective of providing a mounting frame for a radiographic and/or tomographic support that enables one to mount said support for subsequent leveling and determination of the ideal position for making the hole for installation of the implant. This mounting frame is of quite simple construction and avoids the use of sophisticated equipment of expensive acquisition and operation, being therefore accessible even to health units of economically less-favored regions.

Finally, the present invention has the objective of providing a guide for sounding the prosthetic crown, designed to be coupled onto the above-mentioned radiographic support and that enables one to define the exact position and the outline of the future prosthetic crown, correlating it with the data of the alveolar bone obtained by transgigival sounding.

The objectives of the present invention are achieved by means of a reference support for a dental implant, which comprises a body defining a main portion having two free ends, a respective prolonged orthogonal portion extending from each end, the first main portion and the two prolonged orthogonal portions defining a space, the support further comprising association means for the association of at least one more device such as a guide tube positioning apparatus, a prosthetic crown sounding guide, or the like.

Also, the objectives of the present invention are achieved by means of a reference support for a dental implant, which comprises a body defining a first main portion having two free ends, a respective prolonged orthogonal portion extending from each end, the first main portion and the two prolonged orthogonal portions defining a space, the support further comprising at least one through channel for enabling the performance of at least one sounding procedure.

Also, the objectives of the present invention are achieved by means of a prosthetic crown sounding guide comprising a body defining a first main portion having two free ends, a respective prolonged orthogonal portion extending from each end and the two prolonged orthogonal portions defining a space, the guide further comprising association means for association of a reference support for a dental implant, as defined above.

Further, the objectives of the present invention are achieved by means of a prosthetic crown sounding guide comprising a body defining a first main portion having two free ends, a respective prolonged orthogonal portion extending from each end and the two prolonged orthogonal portions defining a space, the guide further comprising at least one through channel for enabling the sounding of a prosthetic crown.

Further, the objectives of the present inventions are achieved by means of a mounting frame for a radiographic and/or tomographic support that enables the aligned positioning of at least one reference support for a dental implant as defined above, over at least one plate/template of a polymeric material.

### BRIEF DESCRIPTION OF THE DRAWINGS

The present inventions will now be described in greater detail with reference to an embodiment represented in the drawings. The figures show:

FIG. 1 is a first schematic view of the radiographic reference support for a dental implant according to the present invention;

FIG. 2 is a second schematic view of the radiographic reference support for a dental implant according to the present invention;

FIG. 3 is a third schematic view of the radiographic reference support for a dental implant according to the present invention;

FIG. 4 is a first schematic view of the tomographic reference support for a dental implant according to the present invention;

FIG. 5 is a second schematic view of the tomographic reference support according to the present invention;

FIG. 6 is a third schematic view of the tomographic reference support for a dental implant according to the present invention;

FIG. 7 is a first schematic view of the prosthetic crown sounding guide according to the present invention;

FIG. 8 is a second schematic view of the prosthetic crown sounding guide according to the present invention;

FIG. 9 is a first schematic view of the mounting frame for the radiographic and/or tomographic reference support according to the present invention;

FIG. 10 is a second schematic view of the mounting frame for the radiographic and/or tomographic reference support according to the present invention;

FIG. 11 is a third schematic view of the mounting frame for the radiographic and/or tomographic reference support according to the present invention.

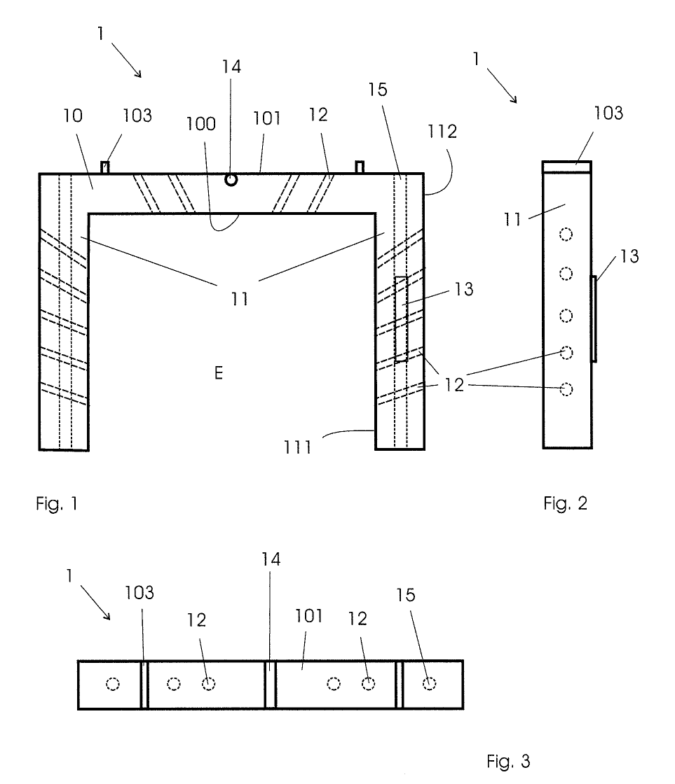

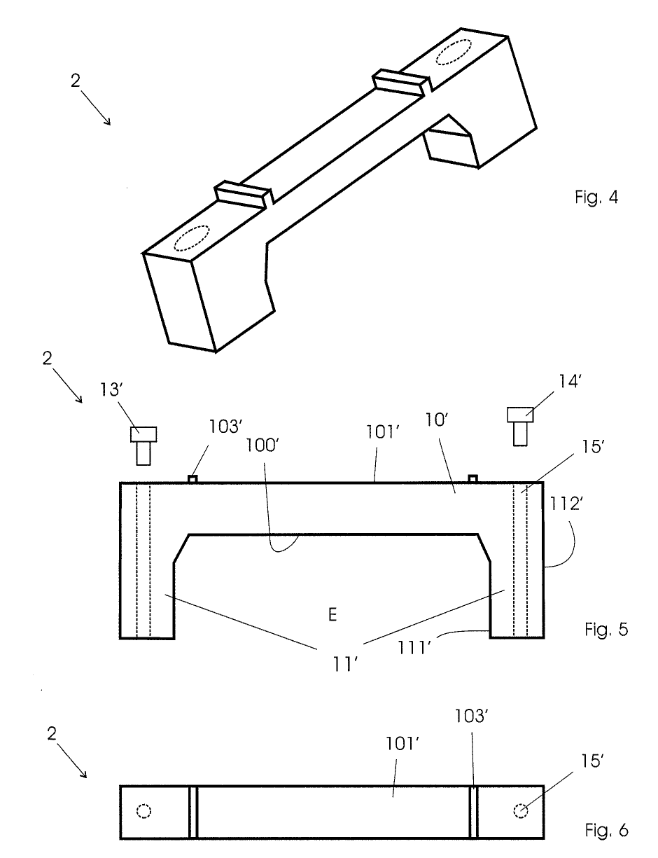

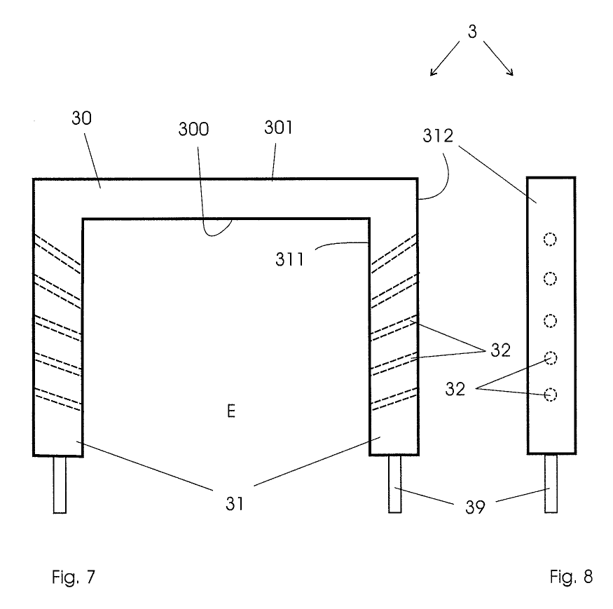

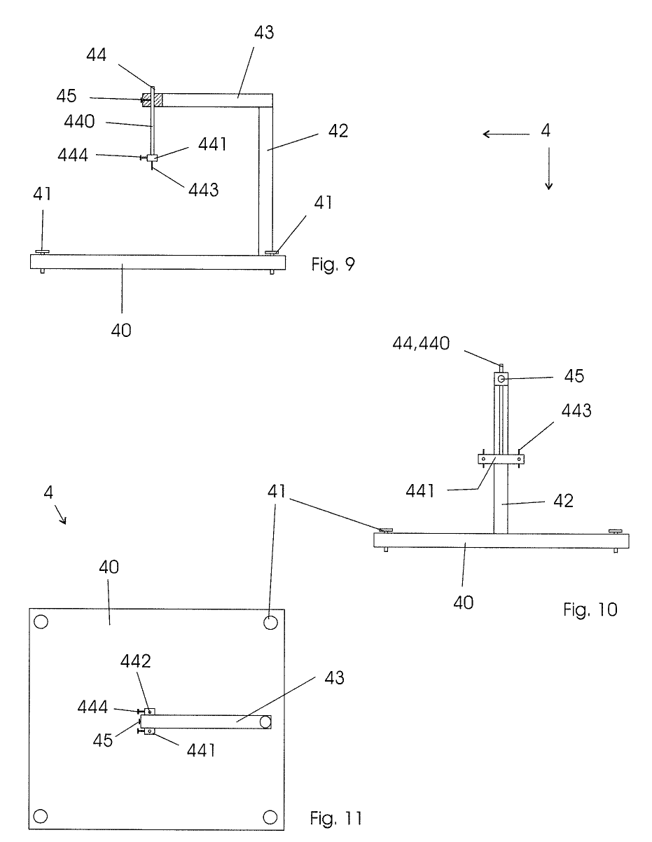

### DETAILED DESCRIPTION OF THE DRAWINGS

The dental implant is commonly used for recovering the appearance of the mouth of the patients who has definitively lost one or more teeth.

As it is known, besides enabling chewing and triturating foods into small portions (capable of going through the esophagus), the teeth have various important actuations, such as the aesthetic appearance which they impart to people as well as the influence they exert in certain forms of speech, whose pronunciation is impaired in the absence of teeth. Therefore, the presence of teeth in one's mouth is very important.

Typically, the dental implant procedure comprises the use of a synthetic tooth (technically called a prosthetic crown), which should be positioned at the place of the missing original tooth with a view to restore the capability of chewing and other properties attributed to tooth, already described above.

The dental crown is fixed to an implant, which in turn is positioned inside a hole made in the bone portion of the maxillary (upper arcade) or the mandible (lower arcade) of the patient's mouth.

The implant must be correctly and firmly fixed to the bone, so that the prosthetic crown will be as stable as a natural tooth.

The conventional procedure of installing an implant comprises making the already mentioned hole in the maxillary or mandible of the patient, installing the implant in the hole, and fixing the prosthetic crown to the implant. A plurality of implant types are used, as for example cylindrical or threaded implants.

More particularly, implants are usually made from titanium alloy (by virtue of the little reactivity and rapid and comfortable association with the bone tissue), and their upper portion comprises means for association to the prosthetic crown, so that the latter will remain correctly installed.

The drilling of the bone tissue to fix the implant must be made at a correct distance from the adjacent tooth, in order to guarantee the correct positioning of the prosthetic crown, in both aesthetic and functional aspects. Therefore, the hole must be such that it will enable the correct anchoring of the implant in the bone.

Even though the issue of positioning the hole is quite delicate, it is commonplace for a professional to make the hole based only on his or her professional experience.

Because of the limited space in the patient's mouth, which renders the work of the professional hard, it is extremely difficult and fallible to determine the correct positioning of the hole and make it without preliminary studies.

The present invention relates to a reference support for a dental implant, a mounting frame for a radiographic and/or tomographic reference support and a prosthetic crown sounding guide which, working together, enable one to determine the location for making the hole with millimetric precision and without the need to use expensive equipment and other pieces of computer-aided equipment. So, this technology is especially ideal for professionals who work in economically less-developed regions or far away from cities or urban centers.

The reference support for a dental implant according to the present invention has two preferred configurative variations, a first variation 1 being designed for use with radiographic equipment, and the second variation 2 being designed for use with tomographic equipment, where this type of equipment is available.

For the sake of facilitating the description, the first configurative variation 1 and the second configurative variation 2 of the support will hereinafter be called radiographic and tomographic support, respectively.

The radiographic support 1 has the main function of radiographic reference to enable the exact determination of the positioning of one or more surgical guide tubes with millimetric precision, which will enable one to make one or more holes in the bone tissue of the patient.

The support 1 further has the function of serving as a base for fixing other instruments, such as a guide tube positioner or a prosthetic crown sounding guide, which is also an object of the present invention and will be described in greater detail below.

Preferably, the radiographic support 1 comprises a body shaped substantially as an inverted “U”, defining a first main portion 10 having two free ends, a respective prolonged orthogonal portion 11 (which configures the legs of the “U”) extending from each end.

The first main portion 10 and the two prolonged orthogonal portions 11 define a space E, which will be occupied by the anatomic portion of the mandible or maxillary when the support 1 is installed in the patient's mouth or in a model corresponding to the dental arcade of the patient (which will be described later).

Further detailing the description, the first main portion 10 comprises a first surface 100 facing the space E and an opposite second surface 101. Analogously, each of the prolonged orthogonal portions 11 comprises a first surface 111 facing the space E and an opposite second surface 112.

Preferably, the prolonged orthogonal projections 11 have the same length and are substantially parallel to each other and substantially perpendicular to the main portion 10, but it is evident that the geometric details may vary freely, since the anatomy of the maxillary and of the mandible vary widely from person to person. It should be pointed out that the protection defined for the present support 1 lies in its concept, not in its specific geometric constitution.

Further preferably, the second surface 101 of the first main portion 10 comprises one or more fitting elements 103, which prevent(s) the guide tube positioning apparatus from turning when the guide tube is attached to the support 1. Preferably, two substantially transverse, rectangular projections 103 are provided, which are positioned symmetrically and equally distant from each other.

The radiographic support 1 further comprises at least one through channel 12, but preferably a plurality of through channels 12, for enabling transgingival sounding.

The channels 12 are preferably in the form of tubular through bores and are positioned in an inclined and strategic manner, so as to enable the sounding of several points at the gums for the correct determination of the anatomy of the bone below them. Evidently, the number, shape, positioning and inclination of the channels may vary widely within the scope of the present invention.

A first radiopaque body 13 (which is not permeable to electromagnetic waves) is provided at one of the prolonged orthogonal projections 11, and a second radiopaque body 14 is provided centrally at the second surface 101 of the first main portion 10. The two radiopaque bodies enable correct visualization of the support 1 upon taking X-ray pictures. It is evident, however, that the number and positioning of radiopaque proof bodies may vary as necessary or if desired.

As a last indispensable constructive characteristic, the support 1 comprises association means for association to a guide tube positioning apparatus or a prosthetic crown sounding guide. Preferably, the means can comprise two threaded bores 15, positioned adjacent the free ends of the first main portion 10. Further preferably, the threaded bores 15 extend into the two orthogonal projections 11, as can be seen in the drawings.

For associating the guide tube positioning apparatus or the prosthetic crown sounding guide (or any other device), the threaded bores 15 receive the system for fixing the former, and the result is a rigid, tight-fitting and secure attachment.

Finally, one should note that the threaded bores 15 may be replaced by any other association means that are functional.

In order to carry out the procedure, the radiographic support 1 should be positioned/mounted on a plate of polymeric material molded from the dental arcade of the patient, which serves as a template and which is already known by those skilled in the art. The plate/template may assume any desired or necessary configuration, and may be made from any material and further may be obtained by any manufacturing process desired, since such variables are not of importance to the present invention.

Preferably, the support 1 is attached to the plate/template by means of any radiolucent joining agent, as for example, self-polymerizing acrylic resin.

The mounting of the support 1 on the plate is made by means of the radiographic and/or tomographic support mounting frame, which is also an object of the present invention and will be described below.

From this point onwards, transgingival soundings are made through the channels 12, until the outline of the bone being sounded is achieved. The sounding is made by drilling the gingival tissue by using a specific instrument in order to determine the shape of the bone under the gums, the thickness of the gingival tissue at that determined point, etc. The instrument is positioned in a respective channel 12. Since there are several channels 12 strategically located, by sounding these several points one achieves a precise profile of the bone.

It should be pointed out that, in the transgingival sounding process without the use of the support 1, since the channels 12 are not present, although the sounding is made at a specific determined point by drilling the acrylic plate produced on the gypsum model of the dental arcade of the patient, the direction that the penetration of the sound follows is random, just as the direction of transfer from the depth of the sound to the gypsum model is random, and this fact may impair the accuracy of the determination of the bone outline in the region being sounded.

After execution of the transgingival soundings, one can fix a prosthetic crown of a radiopaque material (not shown) to the second surface 101 of the first main portion 10, for making the necessary radiographs, which as a rule are the periapical takes/shots.

In order to guarantee the quality of the work, the radiographic support 1 enables the correct fitting of a compatible radiographic positioning device (not shown), enabling one to make the radiographic taking/shot with perfect alignment, guaranteeing the parallelism between the radiographic film and the alveolar border in the region of interest, preventing imprecision in the radiographic image obtained which might impair the correct planning of the location for drilling the hole. Moreover, with the presence of the radiopaque body 13 in one of the prolonged orthogonal projections 11, since the radiopaque body 13 has a known length, one can analyze the radiographic image produced and verify the degree of enlargement with which the image has been projected onto the periapical radiographic film.

In possession of the numerical value corresponding to the degree of enlargement of the radiographic body 13, it is possible to verify the dimensions of the anatomical structures of interest present in the radiographic image and to adjust the dimensions to take into account the degree of enlargement of the image of the radiographic body 13, in order to obtain the compensated value of the dimensions of the anatomical structures of interest in the region. In order for this procedure to be valid, it is sufficient to position the prolonged orthogonal projection 11 that contains the radiopaque body 13 so that it faces the vestibular side, when mounting the radiographic support 1 onto the acrylic plate that covers the gypsum model of the patient's dental arcade.

After making the radiographs, one couples a prosthetic crown sounding guide (which is also an object of the present invention and will be described later) and makes the sounding of the crown.

In possession of the data from the transgingival sounding, of the radiographs and of the prosthetic crown sounding, one has information that, after analysis, enables the planning of the positioning of the guide tube with millimetric precision, which in turn guarantees the drilling of the hole in the bone at the exact location desired. Since the radiographic support 1 has previously known dimensions, and the positions and inclinations of the channels 12 are previously known, it becomes possible that the data collected with the transgingival sounding will be transferred to an index card printed on paper, enabling one to view the outline of the bone without the necessity of cutting out the gypsum model of the patient's dental arcade, to transfer the data obtained by the sounding. Consequently, since there is no need to cut out the model, besides preventing the need for additional time, this prevents further risk of imprecision in the process, since the integrity of the model on which the surgical guide will be produced is preserved.

The radiographic support 1 may be made from any necessary or desirable radiolucent material, all the variations being included in the scope of protection of the invention.

Just as the radiographic support 1 described in detail above, the tomographic support 2 has the main function of being a tomographic reference to enable the exact determination of the positioning of one or more surgical guide tubes 10 with millimetric precision, which will enable the drilling of one or more holes in the patient's bone.

The support 2 also has the function of serving as a base for attaching a guide tube positioning apparatus (not shown). The guide tube positioning apparatus can be, for example, an apparatus substantially as described in the aforementioned '______ application, which has been incorporated herein by reference.

Preferably, the tomographic support 2 comprises a body shaped substantially as an inverted “U”, defining a first main portion 10′ having two free ends, a respective prolonged orthogonal portion 11′ (which configure the “legs” of the “U”) extending from each end.

The first main portion 10′ and the two prolonged orthogonal portions 11′ define a space E, which will be occupied by the anatomic mandible or maxillary portion when the support 2 is installed in the patient's mouth or in a mold corresponding to the patient's dental arcade.

In a more detailed description, the first main portion 10′ comprises a first surface 100′ facing the space E and an opposite second surface 101′. Likewise, each of the prolonged orthogonal portions 11′ comprises a first surface 111′ facing the space E and an opposite second surface 112′.

Preferably, the prolonged orthogonal projections 11′ have the same length and are substantially parallel to each other and substantially perpendicular to the main portion 10′, but it is evident that the geometric details may vary freely, since the anatomy of the maxillary or the mandible varies widely from a person to another. And it is reiterated that the protection defined for the present support 2 lies in its concept, not in its specific geometric constitution.

Further preferably, the second surface 101′ of the first main portion 10′ comprises one or more fitting elements 103′, which prevent the guide tube positioning apparatus from turning when the latter is fixed to the support 2. Preferably, two rectangular projections 103′ are provided, which are substantially transverse and positioned symmetrically and equidistant from each other.

Preferably, the tomographic support 2 does not comprise channels for making gingival sounding, since the tomographic examination itself precisely indicates the anatomy of the bone where one wishes to install the implant, this being its great conceptual difference with respect to the radiographic support 1 described before.

However, it is perfectly possible for the support 2 to have channels to enable soundings. If there are channels present, their form, number, positioning and functionality have already been described above, along with the trangingival sounding which they make possible.

On the tomographic support, there are also first and second radiopaque bodies 13′, 14′ in the preferred form of two radiopaque screws, positioned in localized holes. Preferably, the screws are inserted into two threaded holes 15′, positioned adjacent the free ends of the first main portion 10′. Further preferably, the threaded holes 15′ extend into the two orthogonal projections 11′, as can be seen in the respective figure. It is evident, however, that one may use any other types of radiopaque elements, as suitable or desired.

The two threaded holes 15′ are further used for association of the guide tube positioning apparatus (or any other device), since they receive the system for fixing it, and the result is a rigid, tight-fitting and secure fixation.

Finally, it should be noted that the threaded holes 15′ may be substituted by any other functional association means.

In order to carry out the procedure, the tomographic support 2 has to be positioned/mounted on a plate of any polymeric material, molded from the patient's dental arcade, which serves as a template, as discussed before. The support 2 is fixed to the base by any radiolucent joining agent, as for example, self-polymerizing acrylic resin.

The mounting of the support 2 on the plate is made by means of said radiographic and/or tomographic support mounting frame, which will be described below.

After mounting the support 2 on the mounting frame, one fixes the prosthetic crown of a radiopaque material (not shown) to the surface 10′ of the first main portion 10′, so as to make the tomographic examination(s).

Through the pre-fixed dimensions of the support 2, the radiopaque screws 13′, 14′ and the radiopaque crown, one manages to obtain images having great precision, and the tomographic examination enables one to provide the millimetric positioning of the guide tube on the plate/template, which will result in making a hole for fixing the implant perfectly positioned.

It should be noted that there is a number of known pieces of equipment for making surgical guides for dental implants (Ranalli/TC-Max, Biaggini/Day Set, IVS-Solutions/GonyX, Med 3d, Cadimplant, among other others known to those skilled in the art), in which it is imperative to use some reference device that will produce radiopaque tomographic images that will serve as a base for making the mathematic calculations necessary to determine the ideal position of the planned implant.

However, in the case of the reference devices used by the known equipment, in order for these to be used successfully the model of the patient's dental arcade (which, as a rule, is molded in gypsum) should be mounted on a base of the apparatus and attached to it by means of gypsum or mechanically. This process requires special care in preparing the gypsum model (special cutouts in the base of the model), positioning and aligning the model correctly with respect to the apparatus. In addition, the attachment with gypsum takes considerable time and consumes material (the gypsum itself used in the joining process).

The equipment that will receive the model should have an appropriate base and complex mechanical resources, so that the model can make movements of rotation, inclination and linear sliding. Besides, it is necessary to calculate mathematically the extent of these movements and carry them out with accuracy.

Such complicating factors mean an increase in the cost of industrial production of the equipment, in time and in the complexity of the work of the professional, not to mention an increase in the probability of failures.

The use of the tomographic support 2 of the present invention also produces the images necessary for the planning, but greatly simplifies the work, since the steps listed below are eliminated:
there is no need for special preparation of the gypsum model (specific cutouts in the model base);
no gypsum is used in the process of joining the gypsum model to the guide tube positioning apparatus;
there is no need for mechanical means on the guide tube positioning apparatus to remove the gypsum model, since the tomographic support 2 itself receives the guide tube positioning apparatus;
there is no need to make mathematical calculations for alignment with the guide tube positioning apparatus, since the tomographic support 2 itself aligns the guide tube positioning apparatus;
there is no need to build a base on the guide tube positioning apparatus to receive the model, nor is there any need for the presence of complex mechanical means too move the model.

The tomographic support 2 may be made from any necessary or desirable radiolucent material, all the variations being included in the protection scope of the invention.

The prosthetic crown sounding guide 3 already mentioned above is preferably used in conjunction with the radiographic reference support, since it makes possible to obtain the outline of the future prosthetic crown and that will permit the correct correlation of the position of the prosthetic crown and, as a result, of the implant that fixes it correctly in the desired location. In order to facilitate the description, the prosthetic sounding guide hereinafter will be called simply ‘guide’ 3.

The guide 3 is coupled onto the radiographic support 1 by means of fixing elements 39 that cooperate with the respective means for association 15 of the support. More specifically, the guide 3 has fixing elements 39 in the form of pins that fit into the threaded holes 15 provided in the support 1, providing rigid, tight-fitting and secure fixation.

The guide 3 enables one to define the position and the exact outlines of the future definitive prosthetic crown, enabling one to associate with accuracy the surgical planning to the prosthetic planning during the procedure of planning the dental implant.

The constitution of the guide 3 is very similar in concept to that of the radiographic supports 1 and tomographic support 2, especially with respect to the former, as can be seen hereinafter and from the attached figures.

Preferably, the guide 3 also comprises a body substantially in the form of an inverted “U”, defining a first main portion 10 having two free ends, a respective prolonged orthogonal portion 31 (which configure the “legs” of the “U”) extending from each end.

The first main portion 30 and the two prolonged orthogonal portions 13 define a space E, which will be occupied by the prosthetic crown when the guide 3 is installed over the radiographic support 1.

Further detailing the description, the first main portion 30 comprises a first surface 300 facing the space E and an opposite second surface 301. Likewise, each of the prolonged orthogonal portions 31 comprises a first surface 311 facing the space E and a second, opposite, surface 312.

Preferably, the prolonged orthogonal projections 31 have the same length and are substantially parallel to each other and substantially perpendicular with respect to the main portion 30, but it is evident that the anatomy of the maxillary and of the mandible varies widely from person to person. It should be pointed out that the protection defined for the present guide 3 lies in its concept and interrelation with the support 1, not in its specific geometric constitution.

The guide 3 further comprises at least one through channel 32, but preferably a plurality of through channels 32, to enable the sounding of the prosthetic crown.

Just as in the description of the radiographic support 1, the channels 32 of the guide 3 are preferably shaped as tubular through holes, and are positioned in an inclined and strategic manner, so as to enable the sounding at several points of the prosthetic crown for the correct determination of the desired measurements. Evidently, the number, shape, positioning and inclination of the channels 32 may vary widely within the scope of the present invention.

The fixing elements 39 of the guide 3, which preferably are pins, are positioned so as to extend perpendicularly with respect to the end portions of the prolonged orthogonal projections 31 and are, still more preferably, parallel to each other.

In order to carry out the procedure, the guide 3 is correctly fitted over the radiographic support 1, which in turn is positioned/mounted on a plate of a polymeric material, as already mentioned.

Then, one carries out the soundings of the prosthetic crown through the channels 32. With the data collected in the sounding, one can obtain quite precise information about the shape and position of the future prosthetic crown.

Since the guide 3 has previously defined dimensions, it becomes possible that the data from the crown sounding should be transferred precisely to a template printed on paper and correlated with the data obtained from the transgingival sounding, so that one can plan the position of the implant, perfectly aligned with the future prosthetic crown, with total foreseeability.

The guide 3 may be made from any necessary or desirable rigid material, all the variations being included in the protection scope of the invention.

The radiographic and/or tomographic support mounting frame 4 already mentioned before is preferably used in conjunction with said radiographic and tomographic reference supports 1, 2, enabling the correct alignment thereof over the plates/templates of polymeric material already mentioned.

After all, the precision in the radiographic and tomographic soundings would be of no use if the respective support 1 and 2 were positioned out of alignment with respect to the template (and, in the last analysis, with respect to the dental arcade and the bone to be drilled to place the implant).

In order to facilitate the description, mounting frame 4 for the radiographic and/or tomographic support hereinafter will be called simply “mounting frame” 4.

The mounting frame 4 is, in essence, a levelable and adjustable structure, designed to enable the mounting of each of the radiographic and tomographic reference supports 1, 2, as the case may be, with correct alignment on the respective plate/template of a polymeric material.

The mounting frame 4 comprises a base 40 having at least three leveling elements 41, which enable inclination of the base in any desired direction.

Preferably, the leveling elements are screws 41 that can be screwed into holes provided in the base 40, but it is evident that other means may be employed, such as individually adjustable telescopic projections, or still any other solution that is functional and reliable. Still preferably, four screws 41 are provided, each positioned at a corner of the base 40, which is also preferably square.

Associated to the base, a column 42 is provided, from the upper free end of which a substantially horizontal arm 43 extends. The arm 43 can move rotationally with respect to the column. The arm 43, in turn, has a support carrier 44, which is inside a through bore positioned adjacent its free end and the movement of which is limited by a horizontal locking screw 45.

The support carrier 44 is preferably constituted by a vertical rod 440 fixed at the lower end to a horizontal base 441 having vertical bores 442, through which the carrier pin 443 (preferably two) runs, threaded inside and frontally locked by means of a locking screw 444.

Evidently, such a constructive configuration is merely exemplary, since column, arm and support carrier may have the most varied shapes and be associated to each other in other manners than that described in the preceding paragraph.

In order to positioning correctly the radiographic or tomographic support 1,2, the screws 41 enable the accurate leveling of the base, while the rotation motion between the column 42 and the arm 43 enables greater comfort in positioning the model of the patient's dental arcade (gypsum model) with the plate/template installed.

The carrier pins 443 can move vertically and rotationally, enabling precise adjustments in the operation of mounting the supports 1, 2.

The vertical bores 442 of the horizontal base 441, in turn, have distances from each other corresponding to the sizes of the supports 1, 2 to be used.

Therefore, the movement of the components of the mounting frame guarantees the mounting of the radiographic or tomographic supports 1, 2 in correct alignment on the respective plate/template of a polymeric material.

A preferred embodiment having been described, one should understand that the scope of the present invention embraces other possible variations, being limited only by the contents of the accompanying claims, which include the possible equivalents.

What is claimed is:

1. A reference support for a dental implant, comprising a body defining a first main portion having two free ends and a respective prolonged orthogonal portion extending from each end, the first main portion and the two prolonged orthogonal portions defining a space, the support further comprising association means for associating at least one of a guide tube positioning apparatus and a prosthetic crown sounding guide.

2. A reference support for a dental implant according to claim 1, wherein the first main portion comprises a first surface facing the space and an opposite second surface.

3. A reference support for a dental implant according to claim 1, wherein each of the prolonged orthogonal portions comprises a first surface facing the space and an opposite second surface.

4. A reference support for a dental implant according to claim 2, wherein the second surface of the first main portion comprises one or more fitting elements that prevent the rotation of the device associated thereto.

5. A reference support for a dental implant according to claim 4, comprising two fitting elements in the form of two substantially transverse rectangular projections positioned symmetrically and equidistantly with respect to each other.

6. A reference support for a dental implant, comprising a body defining a first main portion having two free ends and a respective prolonged orthogonal portion extending from each end, the first main portion and the two prolonged orthogonal portions defining a space, the support further comprising at least one through channel for enabling one to carry out at least one sounding procedure therethrough.

7. A reference support for a dental implant according to claim 6, comprising a plurality of channels, each preferably having the shape of a tubular through bore and being positioned in an inclined manner so as to enable the sounding at various points.

8. A reference support for a dental implant, comprising a body defining a first main portion having two free ends and a respective prolonged orthogonal portion extending from each end, the first main portion and the two prolonged orthogonal portions defining a space, the support being positioned/mounted on a plate of a polymeric material molded from a dental arcade of a patient.

9. A support according to claim 8, being fixed to the plate by a radiolucent joining agent.

10. A prosthetic crown sounding guide, comprising a body defining a first main portion having two free ends and a respective prolonged orthogonal portion projecting from each end, the first main portion and the two prolonged orthogonal portions defining a space, the guide further comprising association means for association to a support for a dental implant.

11. A guide according to claim 10, wherein the fixing elements are in the form of pins.

12. A guide according to claim 10, wherein the first main portion comprises a first surface facing the space and an opposite second surface.

13. A guide according to claim 10, wherein each of the prolonged orthogonal portions comprises a first surface facing the space and an opposite second surface.

14. A prosthetic crown sounding guide, comprising a body defining a first main portion having two free ends and a respective prolonged orthogonal portion extending from each end, the first main portion and the two prolonged orthogonal portions defining a space, the guide comprising at least one through channel to enable sounding of a prosthetic crown.

15. A guide according to claim 14, comprising a plurality of through channels in the form of tubular through bores positioned in an inclined manner so as to enable sounding at various points of the prosthetic crown.

16. A radiographic and/or tomographic support mounting frame, configured to provide aligned positioning of at least one reference support for an implant as defined in any one of claims 1 to 9 over at least one plate/template of a polymeric material.
